(19) United States
(12) Patent Application Publication
(10) Pub. No.: US 2021/0071768 A1
(43) Pub. Date: Mar. 11, 2021

(54) Rotating Valve Assembly

(71) Applicant: ST9 Gas and Oil, LLC, The Woodlands, TX (US)

(72) Inventor: Chris Buckley, Montgomery, TX (US)

(21) Appl. No.: 16/642,326

(22) PCT Filed: Sep. 24, 2018
(86) PCT No.: PCT/US2018/052491

§ 371 Date: Feb. 26, 2020

Related U.S. Application Data
(60) Provisional application No. 62/562,241, filed on Sep. 22, 2017.

(51) Int. Cl. F16K 15/02; F04B 53/10

(52) U.S. Cl. CPC F16K 15/026; F04B 53/1025

(57) ABSTRACT

A valve assembly includes a valve body having a circular perimeter and a thickness and a leg body in communication with the valve body. The leg body includes a base and one or more legs that extend outward from the base. The leg body is detachable from the main valve body to permit interchanging. The valve body includes a seal around the circumference of the valve body. The seal extends upward and beneath the midline. The one or more legs are optionally angled or offset from a vertical plane to permit rotations of the valve assembly within its seat.

### TECHNICAL FIELD

The present application relates generally to a reciprocating pump, and in particular to a fluid end having an improved valve assembly.

### DESCRIPTION OF THE PRIOR ART

It is difficult to economically produce hydrocarbons from low permeability reservoir rocks. Oil and gas production rates are often boosted by hydraulic fracturing, a technique that increases rock permeability by opening channels through which hydrocarbons can flow to recovery wells. During hydraulic fracturing, a fluid is pumped into the earth under high pressure (sometimes as high as 50,000 PSI) where it enters a reservoir rock and cracks or fractures it. Large quantities of proppants are carried in suspension by the fluid into the fractures. When the pressure is released, the fractures partially close on the proppants, leaving channels for oil and gas to flow.

Specialized pumps are used to deliver fracture fluids at sufficiently high rates and pressures to complete a hydraulic fracturing procedure or “frac job.” These pumps are usually provided with fluid ends having both reciprocating plungers that place fluids under pressure and valves that control fluid flow to and from the plungers. Fluid ends have many parts that are releasably fastened to one another so that they can be repaired or replaced. These fluid ends experience large amounts of internal stresses from turbulent flows and cavitation as the fracture fluids are passed through. By the nature of its operation a reciprocating pump or fluid end induces turbulent flow and cavitation into the system. These effects are detrimental to the whole pumping system. These stresses reduce the life of the fluid end and its internal components, such as valve assemblies.

Current valve assemblies used in the fluid ends are a single body where the top portion or main body (valve) is integrally formed to include one or more legs. As the assembly is a single part, both the main body and lower leg area are made of the same materials. This design has increased the costs of parts. The max forces exerted on any portion of the part end up dictating the material selection for the entire part. Another disadvantage of conventional designs is that the valves typically contact the seat at the same orientation over and over. As variations in material characteristics and parts may exist, repetitive contacting of the valve and seat in the same orientation can exacerbate potential flaws in the parts and lead to failure.

Although great strides have been made with respect to fluid end design and its internal components, considerable shortcomings remain. An improved valve assembly for a fluid end is needed that addresses common shortcomings of conventional fluid ends.

### SUMMARY OF THE INVENTION

It is an object of the present application to provide a valve assembly that has a detachable leg body from a main valve body. This allows the assembly to be made from different materials to permit reduced manufacturing costs as each body is subject to different stresses in the fluid end. The detachable leg body may be threaded into the main valve body and held via interference fit. A secondary retention method may also be used in the form of an engineering adhesive. This adhesive may be applied to the thread detail prior to assembly of the bodies. This helps prevent disassembly during operation.

An additional object of the present application is to facilitate the proper torqueing of the leg body into the main valve body. A socket drive feature is included in the leg body of the valve assembly. The feature may include a socket having any numbered sides or shape, in this application a six-sided hex is used to drive the legs into the main valve body. This feature is also used to apply the required torque giving a sound mechanical joint.

Another object of the present application is to permit for the optional offsetting/angling of the legs in the leg body. Offsetting the legs creates an angular leg configuration where the legs are angled and/or offset to ensure that the mating faces of the valve and seat don't continually contact in the same position. Operation of the valve acts to clock the valve orientation relative to the seat so as to minimize the repeated impact and hitting of the valve assembly on the seat in the same orientation. The number of legs and angle can be any number and/or not all legs need to be angular. The angle of the legs is determined to a ratio which is sufficient to rotate the valve the required angular displacement to ensure differential mating contact between the valve and seat every cycle.

A further object of the present application is to provide a polymer seal about the circumference of the main valve body. The shape of the Polymer or nonmetallic profile is the external radius does not intersect beyond the external major diameter and transitions into an inward facing taper of an angle towards the center. Ultimately the invention may take many embodiments but features. In these ways, this assembly overcomes the disadvantages inherent in the prior art.

The more important features of the assembly have thus been outlined in order that the more detailed description that follows may be better understood and to ensure that the present contribution to the art is appreciated. Additional features of the system will be described hereinafter and will form the subject matter of the claims that follow.

Many objects of the present assembly will appear from the following description and appended claims, reference being made to the accompanying drawings forming a part of this specification wherein like reference characters designate corresponding parts in the several views.

Before explaining at least one embodiment of the system in detail, it is to be understood that the assembly is not limited in its application to the details of construction and the arrangements of the components set forth in the following description or illustrated in the drawings. The assembly is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present assembly. It is important, therefore, that the claims be regarded as including such equivalent constructions insofar as they do not depart from the spirit and scope of the present assembly.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side section view of a fluid end with internal components, including a valve assembly according to an embodiment of the present application.

FIG. 2 is a side view of the valve assembly of FIG. 1.

FIG. 3 is a bottom view of the valve assembly of FIG. 1.

FIG. 4 is an upper perspective view of the valve assembly of FIG. 1.

FIG. 5 is a lower perspective view of the valve assembly of FIG. 1.

FIG. 6 is a bottom view of a main valve body in the valve assembly of FIG. 2.

FIG. 7 is a side view of the main valve body of FIG. 6.

FIG. 8 is a side view of a leg body of the valve assembly of FIG. 2.

FIG. 9 is a side section view of the leg body of FIG. 8.

FIG. 10 is a side view of an alternate embodiment of the valve assembly of FIG. 2.

While the assembly of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the assembly described herein may be oriented in any desired direction.

The assembly in accordance with the present application overcomes one or more of the above-discussed problems commonly associated with conventional valve assemblies discussed previously. In particular, the valve assembly of the present application provides for a detachable connection between a main valve body and a leg body. This permits for more tailored material selection in an effort to facilitate reduced costs and increased part life. Additionally, the valve assembly is configured to permit for the clocking/rotation of the valve assembly in the valve seat to create a change in orientation between the valve assembly and the seat when in operation. An additional socket Feature or fastening location is used to aid in communicating the bodies of the valve assembly. These and other unique features of the assembly are discussed below and illustrated in the accompanying drawings.

The assembly will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The assembly of the present application is illustrated in the associated drawings. The valve assembly includes a main valve body and a leg body. The leg body is detachable from the main valve body. Any type of detachable connection method may be used. An additional engineering adhesive may be optionally used to enhance the coupling of the parts. The leg body includes one or more legs that are aligned to have an offset or angled orientation. Additional features and functions of the device are illustrated and discussed below.

Referring now to the Figures wherein like reference characters identify corresponding or similar elements in form and function throughout the several views. The following Figures describe the assembly of the present application and its associated features. With reference now to the Figures, an embodiment of the valve assembly and method of use are herein described. It should be noted that the articles “a”, “an”, and “the”, as used in this specification, include plural referents unless the content clearly dictates otherwise.

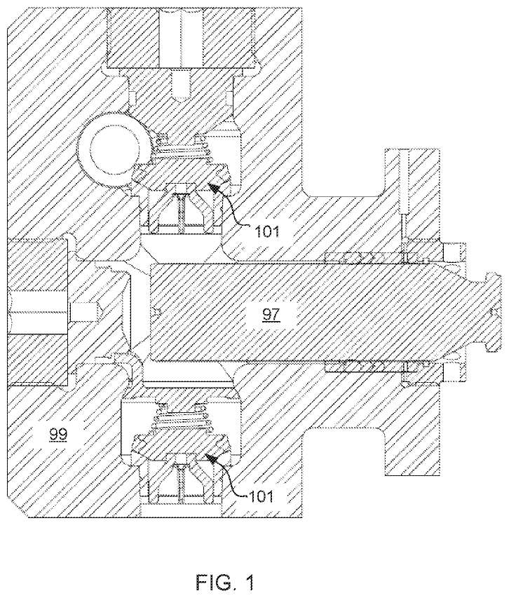

Referring now to FIG. 1 in the drawings, a side section view of a fluid end assembly is illustrated. Fluid end 99 is configured to induce a pressure differential internally that permits for the intake and subsequent discharge of working fluid through a suction valve and a discharge valve. The pressure is induced through the reciprocation of a plunger 97. Within the suction valve and the discharge valve is a valve assembly 101 according to an embodiment of the present application. Assembly 101 is seated on a seat and operates in accordance with the motion of plunger 97. As assembly 101 presses against the internal spring, working fluid is allowed to pass. The spring pushes the valve assembly 101 back against the seat as motion of the plunger changes.

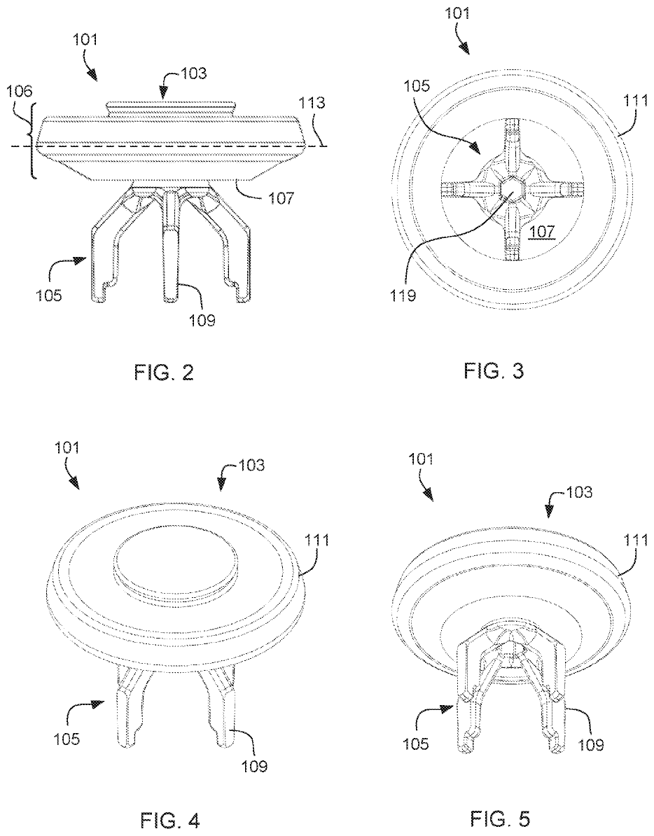

Referring now also to FIGS. 2-5 in the drawings, assorted views of valve assembly 101 is provided. Assembly 101 is a dual part body that is configured to permit for the separation of the assembly into at least two part. Assembly 101 includes a main valve body 103 and a leg body 105. Valve body 103 includes a circular perimeter and a thickness 106. Leg body 105 is in communication with valve body 103 such that it is ideally centrally located along a lower surface 107. Leg body 105 is detachable from valve body 103. This allows for the use of dissimilar materials to be jointed together in the different parts of the assembly, such that material and manufacturing process used with leg body 105 may be different from those with valve body 103. For example, valve body 103 can be forged to give the desired physical properties of a part under compressive load and leg body 105 can be cast to give a detailed intricate shape or form. It is understood that leg body 105 and valve body 103 may be made from at least one of a different material and/or a different manufacturing process in order to facilitate a reduction in manufacturing costs, enhance performance through material selection and shaping, and increasing life span of assembly 101 as a whole. For example, leg body 105 may be forged, formed through a cast manufacturing process, or even machined from a solid bar. Likewise, valve body 103 may be formed through a cast manufacturing process or even machined from a solid bar.

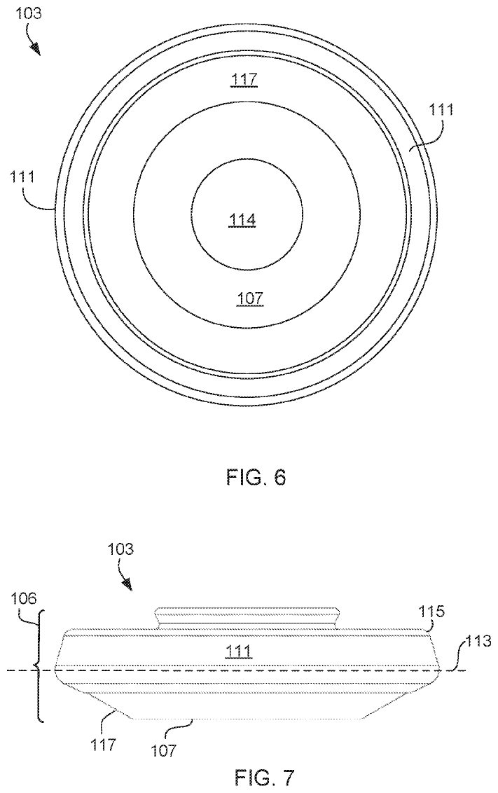

Referring now also to FIGS. 6 and 7 in the drawings, views of valve body 103 are provided. Valve body 103 is seen from a bottom view in FIG. 6. In this view, a centrally located aperture 114 is located along surface 107. Aperture 114 is configured to mate with leg body 105 and facilitate detachable operation.

Valve body 103 has a major diameter that extends across its widest point. A midline 113 is shown in FIGS. 2 and 7 defining the major diameter. Valve body 103 has an upper side surface 115 and a lower side surface 117. Valve body 103 further includes a seal 111 extending circumferentially around an outer surface. Seal 111 may be a urethane seal or any non-metallic member materialistically distinct from valve body 103. As seen in the Figures, seal 111 extends both above and below midline 113 along both upper side surface 115 and lower side surface 117. Lower side surface 117 is a conical surface of a frustum. It is understood that seal 111 may extend either above, below, or be only isolated to midline 113.

As seen in FIG. 7, seal 111 above midline 113 is angled inward as seen similarly with that of seal 111 below midline 113. The shape of the Polymer or nonmetallic profile of seal 111 is the external radius and does not intersect beyond the external major diameter and transitions into an inward facing taper of an angle towards the center. Additionally, the contact face area of the polymer or nonmetallic portion of the valve must be set in accordance with design and performance constraints.

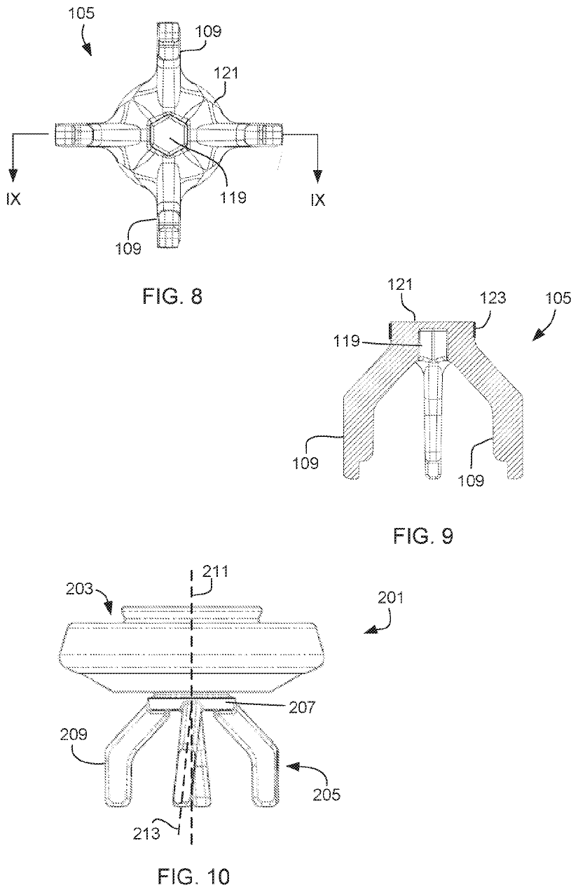

Referring now also to FIGS. 8 and 9 in the drawings, views of leg body 105 are illustrated. Leg body 105 includes a socket feature 119, a base 121, and one or more legs 109. Legs 109 extend out away from base 121 along a defined plane. Base 121 extends upward, opposite that of legs 109. Base 121 is configured to engage aperture 114 of valve body 103. Base 121 may be threaded in some embodiments.

The valve assembly may also include socket feature 119 for use during assembly and breakdown of leg body 105 and valve body 103. Socket feature 119 is recessed into base 121 and located centrally between legs 109. It is accessed by passing between legs 109. Socket feature 119 is used to torque leg body 105 into valve body 105. This feature is also used to apply the required torque giving a sound mechanical joint. Socket feature 119 may feature any number of sides or shape. In this set of Figures, a six-sided hex shape is shown but any shape having three or more sides is suitable.

In particular with FIG. 9, a secondary retention method can be used to help the two bodies remain connected during use. Namely an engineering adhesive 123 can be applied to the thread detail in either part prior to assembly. This prevents disassembly during operation. The engineering adhesive is selected as to not be affected by the processing temperature of the valve pre-heat before injection molding and/or the post processing temperature after molding. The engineered adhesive has a temperature range between 80 and 350 deg C.

Referring now also to FIG. 10 in the drawings, a side view of an alternate embodiment of assembly 101 is provided. Valve assembly 201 is similar in form and function to that of assembly 101 except with respect to its leg body. Assembly 201 includes a valve body 203 and a leg body 205. Legs 209 are configured to extend outward and away from a base 207. In FIG. 10, the legs 209 have an angular orientation to base 207. The legs are angular and offset to ensure that the mating faces of the valve and seat don't continually contact in the same position. The angular orientation of the legs help to induce a rotation of the valve body 203 in relation to a valve seat or the fluid end casing of fluid end 99. The precise shape or contour of the one or more legs 209 are customizable for their particular use.

In FIGS. 2-5 and 8-9, legs 109 are illustrated as having a vertical orientation in that each leg extends away from base 121 along a vertical plane. As seen in FIG. 10, the one or more legs 209 are orientated so as to extend away from base 207 in an angled offset orientation such that at least one of the legs 209 are non-vertical. Vertical plane 211 is defined. The plane 213 of leg 209 is illustrated adjacent to plane 211 so as to show the defined angle between them. The bent/angled leg orientation causes valve assembly 201 to clock or rotate related to its seat as the flow of working fluid passes beyond the valve. This clocking or rotational effect allows the valve assembly 201 to minimize the repeated impact and prevent hitting the same part of the valve and seat combination during operation.

It is understood that the number of legs and angle is not particularly limited to any amount. Any number of legs may be used, and they may be at any angular orientation. Not all legs have to be set at the same angular orientation in some embodiments. It is also known that not all the legs have to have any particular set angular orientation either. The angle of the legs is determined to be a ratio which is sufficient to rotate the valve the required angular displacement to ensure differential mating contact between the valve and seat every cycle.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A valve assembly, comprising:
a valve body having a circular perimeter and a thickness; and
a leg body in communication with the valve body, the leg body including a base and one or more legs;
wherein the leg body is detachable from the main valve body.

2. The assembly of claim 1, wherein the leg body and the valve body are made from at least one of a different material and a different manufacturing process.

3. The assembly of claim 1, wherein the leg body is forged.

4. The assembly of claim 1, wherein the leg body is formed from a cast manufacturing process.

5. The assembly of claim 1, wherein the leg body is machined from a solid bar.

6. The assembly of claim 1, wherein the valve body is formed from a cast manufacturing process.

7. The assembly of claim 1, wherein the valve body is machined from a solid bar.

8. The assembly of claim 1, wherein the valve body includes a seal extending circumferentially around an outer surface.

9. The assembly of claim 8, wherein the seal extends below a midline of the valve body along a lower side surface.

10. The assembly of claim 8, wherein the seal extends above the midline of the valve body along an upper side surface.

11. The assembly of claim 8, wherein the seal is angled inward above a midline of the valve body.

12. The assembly of claim 1, wherein the leg body includes a socket feature for torqueing the leg body into the valve body.

13. The assembly of claim 12, wherein the socket feature is a hex shaped socket with six sides.

14. The assembly of claim 12, wherein the socket feature includes three or more sides.

15. The assembly of claim 12, wherein the socket feature is recessed into the leg body.

16. The assembly of claim 12, wherein the socket feature is located in the base of the leg body.

17. The assembly of claim 1, wherein the one or more legs are offset.

18. The assembly of claim 1, wherein the one or more legs extend away from the base in an angled offset orientation such that at least one of the one or more legs is non-vertical.

19. The assembly of claim 1, further comprising:
an engineering adhesive in communication with the base for insertion into an aperture of the valve body.
